(19) United States
(12) Patent Application Publication
(10) Pub. No.: US 2024/0169080 A1
(43) Pub. Date: May 23, 2024

(54) DISTRIBUTED FILE SYSTEM WITH SECURE MULTI-PARTY ACCESS

(71) Applicant: DEVR INC., Dover, DE (US)

(72) Inventor: Shashi Shive Gowda, Tallahassee, FL (US)

(73) Assignee: DEVR INC., Dover, DE (US)

(21) Appl. No.: 17/990,253

(22) Filed: Nov. 18, 2022

(51) Int. Cl. G06F 21/62

(52) U.S. Cl. CPC G06F 21/6218

(57) ABSTRACT

A distributed file system for secure multi-party computing access to a plurality of distributed files is presented. For instance, the distributed file system includes a cloud-based data store, at least one tracking system, a distributed ledger, and first and second enterprise access systems. The cloud-based data store is configured to store the plurality of distributed files and regulate secure multi-party computing access to the plurality of distributed files. The at least one tracking system is configured to track transactions related to the plurality of distributed files, the transactions including at least read transactions and write transactions. The distributed ledger comprises at least one block chain and is configured to validate the transactions related to the plurality of distributed files. The first enterprise access system comprises a first local data store and has access to the cloud-based data store, the at least one tracking system and the distributed ledger.

### CROSS REFERENCE TO RELATED APPLICATIONS

This application is a non-provisional patent application filed under relevant portions of 35 U.S.C. § 111 and 37 CFR § 1.53.

### BACKGROUND

Emerging technologies have historically challenged enterprises due to the complexities of data trust and validation, most specifically in regulated industries that require granular traceability and auditability. Conventional file systems are operated and controlled by a single party. In such a case, secure access cannot be guaranteed for multiple parties. For example, in a conventional distributed file system, a centralized file system is controlled by an administrative party, who may modify, delete, and otherwise change the files without accountability to any third party. In addition to changing the content of files, the administrative party may also change metadata of the files without accountability to any third party. Therefore, the use of distributed file systems is based on a centralized trust model, in which a trusted intermediary is trusted to take care of the file system and its contents. Trust based models cannot handle situations in which rogue users or hackers take control of the system to modify files.

For example, early notions of distributed file systems started with file sharing such as Napster. In systems such as Napster, one person would digitize media content and make it available for global communities, but the content of the data could not be verified. Next, solutions such as BitTorrent emerged. By contrast with Napster, BitTorrent could not be blocked because it was decentralized, and therefore could not be blocked by regulators and law enforcement. The foundation of BitTorrent was a so-called distributed hash table. Such a hash table was stored in the so-called cloud, and was distributed so no one node had to know every hash entries. Then, solutions such as Cassandra emerged in an attempt to solve enterprise problem Cassandra was designed with a distributed hash table inside one given enterprise but could not function with security not between enterprises. So-called Interplanetary File System (IPFS) emerged, which is in essence a legal version of BitTorrent. IPFS provides a more granular retrieval mechanism than BitTorrent. In BitTorrent you have to download all the files and folders, but IPFS allows users to retrieve specific files amongst many hierarchical folders. But these solutions also lack security features between multiple parties, including secure change management. In essence, IPFS is a glorified DropBox type solution, which allows sharing of files without accountability (traceability and auditability) and proof of data integrity.

As stakeholders continue to demand data privacy and security, trust-based models continue to lag stakeholder expectations and regulatory and legal requirements. The industry continues to grapple with the lack of secured and trustworthy distributed file system techniques.

### BRIEF SUMMARY

In one embodiment, a distributed file system for secure multi-party computing access to a plurality of distributed files is presented. For instance, the distributed file system includes a cloud-based data store, at least one tracking system, a distributed ledger, and first and second enterprise access systems. The cloud-based data store is configured to store the plurality of distributed files and regulate secure multi-party computing access to the plurality of distributed files. The at least one tracking system is configured to track transactions related to the plurality of distributed files, the transactions including at least read transactions and write transactions. The distributed ledger comprises at least one blockchain and is configured to validate the transactions related to the plurality of distributed files. The first enterprise access system comprises a first local data store and has access to the cloud-based data store, the at least one tracking system and the distributed ledger. The second enterprise access system comprises a second local data store and having access to the cloud-based data store, the at least one tracking system and the distributed ledger. The distributed file system enables the first and second enterprise access systems to access at least one distributed file of the distributed file system, the at least one distributed file comprising multiple data structures. The distributed file system regulates the first enterprise access system to allow first transactions on a first subset of the multiple data structures and the second enterprise access system to allow second transactions on a second subset of the multiple data structures, such that the first and second subsets are different subsets and the first and second transactions are different transactions. The distributed file system tracks the first and second transactions using the at least one revision tracking system and validates the first and second transactions using the distributed ledger.

The above embodiment(s) are exemplary only. Other embodiments as described herein are within the scope of the disclosed subject matter.

### BRIEF DESCRIPTION OF THE SEVERAL VIEWS OF THE DRAWINGS

So that the manner in which the features of the disclosure can be understood, a detailed description may be had by reference to certain embodiments, some of which are illustrated in the accompanying drawings. It is to be noted, however, that the drawings illustrate only certain embodiments and are therefore not to be considered limiting of its scope, for the scope of the disclosed subject matter encompasses other embodiments as well. The drawings are not necessarily to scale, emphasis generally being placed upon illustrating the features of certain embodiments. In the drawings, like numerals are used to indicate like parts throughout the various views, in which:

FIG. 1 illustrates a distributed file system, in accordance with one or more aspects set forth herein;

FIG. 2 illustrates a blockchain network, in accordance with one or more aspects set forth herein;

FIGS. 3A-3B illustrate a security gateway, in accordance with one or more aspects set forth herein;

FIGS. 4A-4B illustrates data source provisioning, in accordance with one or more aspects set forth herein;

FIGS. 5A-5C illustrates data source registration, in accordance with one or more aspects set forth herein;

FIGS. 6A-6D illustrates writing data of interest, in accordance with one or more aspects set forth herein;

FIGS. 7A-7D illustrate reading data of interest, in accordance with one or more aspects set forth herein;

FIGS. 8A-8B illustrates data subscription, in accordance with one or more aspects set forth herein;

FIGS. 9A-9C illustrates data notification and retrieval, in accordance with one or more aspects set forth herein; and

FIGS. 10A-10B illustrates a working example of the present disclosure, in accordance with one or more aspects set forth herein.

Corresponding reference characters indicate corresponding parts throughout several views. The examples set out herein illustrate several embodiments, but should not be construed as limiting in scope in any manner.

### DETAILED DESCRIPTION

The present disclosure relates to distributed file systems, and more specifically to distributed file systems that include secure multi-party computing access to the files. Conventional distributed file systems, and conventions systems based on distributed ledger technologies, blockchain technologies, and the like, fail to provide secure multi-party access to distributed files. As described in detail below, the present techniques include improvements in components such as distributed ledgers, including distributed ledgers enabled and secured by blockchain technology, append-only cloud file storage, revision or code repositories, and other building blocks to create a trusted data framework that enables data-velocity, data-variety, data-volume. The present techniques are generally applicable to all aspects of enterprise solutions and development, including but not limited to emerging technology ecosystems solutions such as IoT, IIoT, AI/ML, Fintech, Smart Health, and others.

The present technique solves the problem of sharing of data streams, not just data in the form of files. For instance, things that keep producing data, as in the Internet of Things (IoT), including recurring, repetitive data. For example, a temperature sensor continuously sends temperature data. This is not really analogous to a file, and that is one reason conventional solutions have failed to solve secure multi-party computing access to such data. The present techniques allow such data streams to be managed and tracked back to the original point of introduction, so that there is an ability to manage what entity has made any changes to such data. By contrast, file based techniques simply show who accessed a file, and who changed a file, but cannot give granular detail into who accessed and changed what data within a file, and cannot trace changes back to the point of origin. Advantageously, the present technique provides a technological improvement to distributed file system technology that allows for a governance model, so that multiple parties can trust the data streams that are part of the distributed file systems. By contrast, conventional solutions include a trust by ownership model, in which an assumption is made that the entity controlling the distributed file system is to be trusted. But this trust is misplaced for a variety of reasons, including hacking, bad faith actors, etc.

The present technique enables a unique separation of ownership such that multiple different parties can share distributed data, and portions thereof. Advantageously, and as explained below, the technological solutions described herein allow more than three parties to share distributed files such that each party may have read or read/write access to different subsets of a given distributed file, standing in contrast to the all-or-nothing solutions that are conventionally available. As explained in full detail herein, the existence of distributed files is managed by using a blockchain,

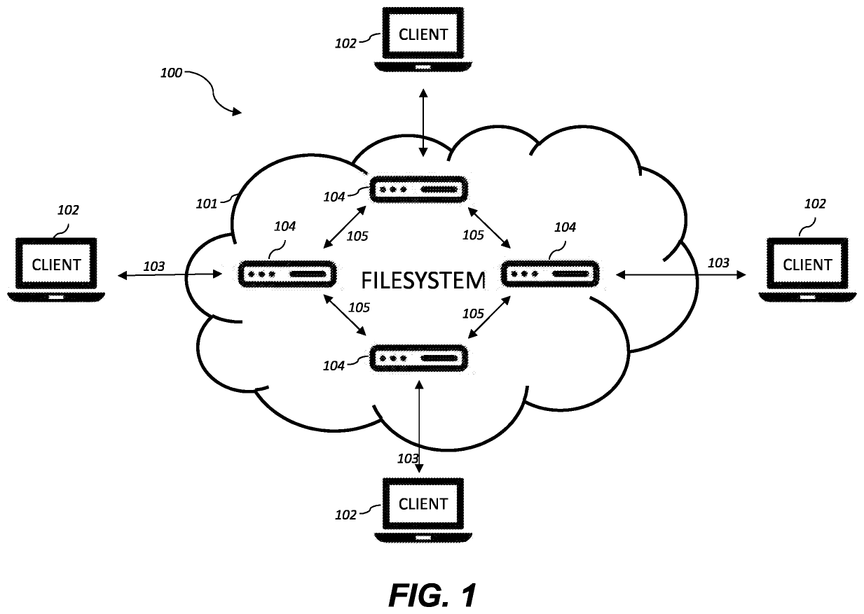

By way of example, FIG. 1 illustrates a distributed file system 100, in accordance with one or more aspects set forth herein. In one embodiment, distributed file system 100 is an append-only file system, allowing for data to be stored and modified. For instance, one implementation of distributed file system 100 may be a decentralized cloud-hosted storage and replication environment with secure application programming interfaces (APIs) that provide PUT and GET capabilities to authorized clients. Distributed file system 100 may be implemented on a computer or server, including any computing platform known in the art. Cloud-hosted storage of distributed file system 100 includes, but is not limited to, any storage-server that can run the application required to support the API communication with the clients 102 and the replication with the other storage servers 104. Storage server 104 may be connected to a network 101 and the clients 102 may be connected to a network. This network 101 can be the public Internet, or a private Intranet, or a mix of both, or any other network known in the art. Replication includes file and/or data duplication across one or more participating (in this specific file system 100) storage servers 104.

With respect to an interface between clients 102 and file system 100, an API may be used. For instance, an API may allow a client to ‘PUT’, or upload’ a file or a folder-of-files to file system 100. In the present technique, no limit to the type of file that can be uploaded is placed, including any limits on volume, variety or velocity. In one example, the API of file system 100 responds to the client with a ‘URL’ and a file-signature (e.g., a hash or checksum) that can be used to verify the integrity of the file during subsequent retrieval. Any type of hash or checksum or combination of hash and checksum known in the art may be employed. Continuing, for example, the API can allow an authenticated client 102 to ‘GET’ a file using a ‘URL’. In such a case, the integrity of the file can then be verified using the file signature the client 102 received during the ‘PUT’ operation.

The interface 105 between file system servers 104 allows secure replication of files. For instance, the file system 100 uses file synchronization and the ability to configure and/or balance storage efficiency with the redundancy required to ensure that files are always available.

By way of overview, a distinction is now explained with respect to metadata and data. Data is the data, and metadata is the description of the data. For example, in a word processing document, the filename is metadata and the file contents is data. In another example, a so-called dumb temperature sensor that only outputs a temperature reading is outputting data. But the context of that data, including the location, the time, etc., is metadata. Without the metadata, the data is meaningless and without context. The present technique allows for securely sharing both metadata and data, such that multiple different parties can be assured of the integrity of both metadata and data, individually and together. For example, as noted below, security gateways are employed to encrypt both the metadata and data together into a combined record. This prevents any manipulation of the metadata.

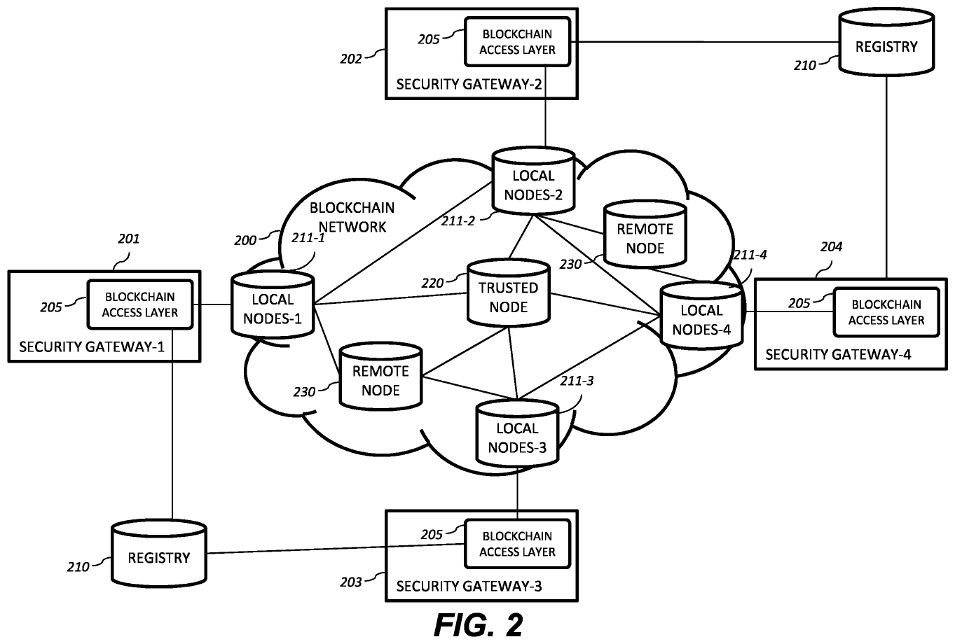

FIG. 2 illustrates a blockchain network 200, in accordance with one or more aspects set forth herein. For instance, blockchain network 200 and the access layer 205 to the blockchain network may be used by security gateways 201-204. The blockchain employed can be any blockchain that supports fungible token (FT) creation.

In one example, Security gateways 201-204 each have access to locally owned blockchain nodes 211-214. For instance, local nodes 211-1-211-4 each have network access to 2 types of blockchain nodes, including remote nodes 230, which are responsible for transaction, memory pool and block replication, and trusted nodes 220, which may have explicit authorization for block creation, such as nodes designated and authorized by the blockchain network owners for block creation, or have implicit authorization for block creation, such as through mining, proof-of-work or similar consensus mechanisms.

In one specific implementation that is within the scope of the present technique, only local nodes 211-214 can create transactions, and only trusted nodes 220 can create blocks. Note that a local node can also be a remote node, and can also be a trusted node. And, a local node could include multiple nodes, each associated with a single security gateway.

Continuing, registry 210 includes registration of new non-fungible tokens (NFTs) and FTs, which can be registered by each security gateway, e.g., security gateways 201-204, for NFTs and FTs that they create (via the blockchain access layer 205). In one example, a security gateway 201-204 may only create a registry 210 entry for an asset/token directly created by that specific security gateway 201-204. In another example, the registry 210 can deny registration for an asset based on business rules.

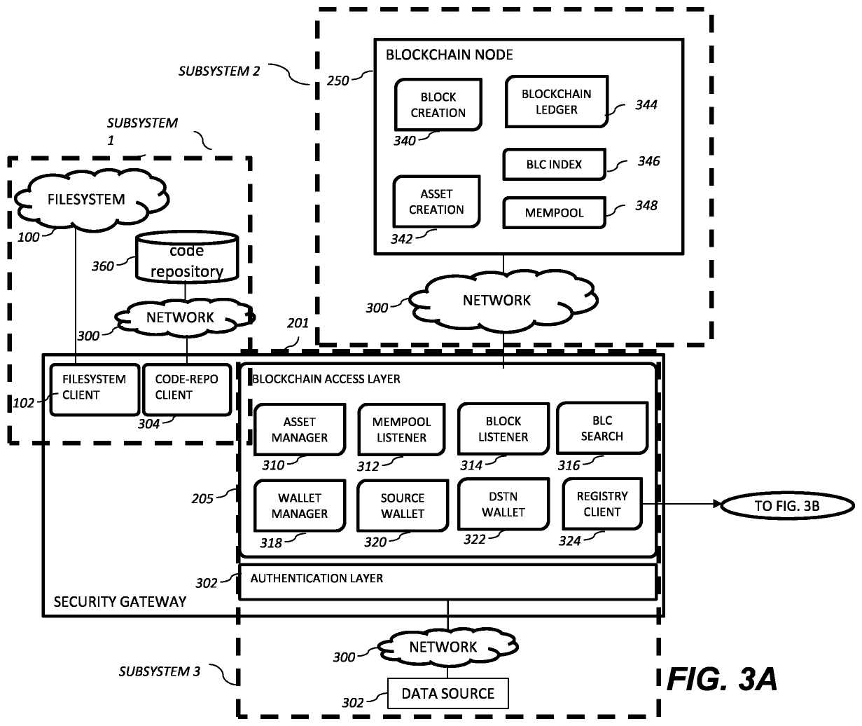

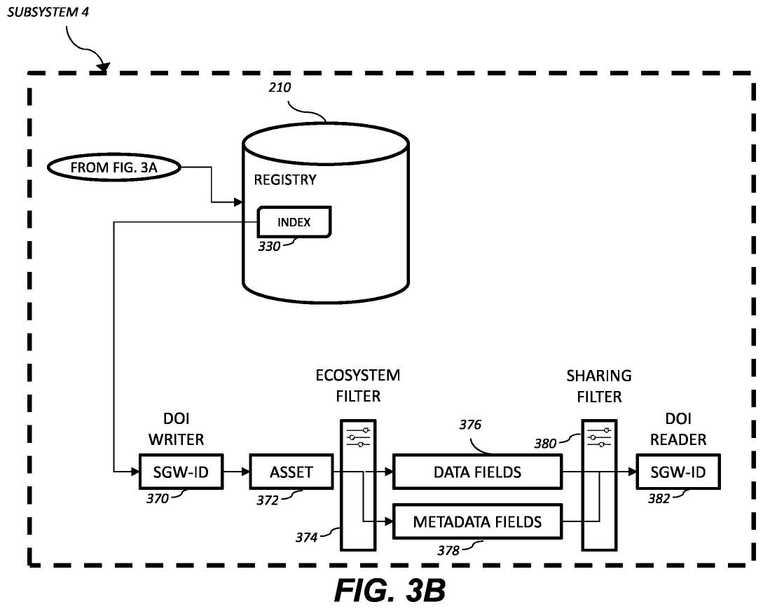

FIGS. 3A-3B illustrate a security gateway 201 in a broader environment, in accordance with one or more aspects set forth herein.

In order to describe the various aspects of FIGS. 3A-3B, first, an example subsystem, labeled subsystem 1, will be discussed. In subsystem 1, a file system 100 as previously described, is an append-only, network (cloud) hosted, file storage system with simple ‘GET’ and ‘PUT’ APIs. The code repository element 360 is a used to track the history of data of interest (DOI) events from a single data source 302. In one example, code repository element 360 may use or include GIT, Mercurial, SVN, Fossil, or any other code repository.

Next, a subsystem labeled subsystem 2 will be discussed. Block creation 340 is a capability for trusted nodes only, which allows a node to create a new block in the blockchain network based on a combination of certain criteria, including, but not limited to the following: Authorization to create Blocks; Authorization for ‘mining’, or other proofs-of-consensus; TX verification; TX volume; Time-between-Block-creation.

Asset creation 342 is the capability to create a FT and an NFT. For instance, a fungible token (FT) is a blockchain asset that has a monetary attribute that allows funds (usually cryptocurrency) to be allocated, divided, exchanged and transferred across the distributed ledger as a component of a cryptocurrency transaction, and a non-fungible token (NFT) is a blockchain asset that has no monetary attribute, either due to a zeroing of funds, or lack of funds, or inability to assign funds.

In one example, an NFT can be recognized and authenticated by the blockchain network, but is not capable of being allocated, divided, exchanged or transferred across the distributed ledger as a component of a cryptocurrency transaction due to its lack of a monetary attribute.

A blockchain ledger is a basic decentralization of the ledger for transaction tracking.

BLC index 346 is the ability for the Node to index and retrieve transaction information from the Blockchain network.

Memory pool 348 may be described as follows. When a security gateway creates a blockchain transaction, it will be added to the memory pool (mempool) 348 as an unconfirmed transaction in some implementations. In such an example, this transaction will be replicated across the mempools 348 of the other nodes (local nodes 211-214, remote nodes 230 and trusted nodes 220; see FIG. 2) within the blockchain network 200. The trusted node 220 will process and, in some proof-of-consensus implementations, will provide a proof-of-work for the verification of transactions in the mempool 348 whenever it generates a new block on the blockchain. In some implementations, any transaction included in a new block transitions from an ‘unconfirmed’ transaction to a ‘confirmed’ transaction. All transactions that are included in a new block are removed from the mempool 348, and this removal will then be replicated across the mempools of the other nodes (local nodes 211-214, remote 230 and trusted nodes 220).

Next, a subsystem labeled subsystem 3 will be discussed. Subsystem 3 includes asset manager 310, which allows a security gateway 201-204 to create FTs and NFTs, combinations of FTs and NFTs, and nested dependencies of FTs and NFTs and assign them flexibly to data sources 302. Newly created FTs and NFTs are then stored into one or more wallets, either source wallets 320 or destination wallets 322. Mempool listener 312 is responsible for listening to new transactions in the mempool 348 of the local nodes 211-214 of security gateway 201-204, respectively. Block listener 314 is responsible for listening to new block creation events of the local nodes 211-214 of security gateway 201-204. BLC search is responsible for querying the local nodes 211-214 of security gateway 201-204 for blockchain transaction history and details. Wallet manager 318 is responsible for managing the NFTs and FTs created by the asset manager 310. Source wallet 320 provides the source of funds for outgoing FT cryptocurrency transactions. These outgoing transactions can be for destination wallets 322 in remote security gateways 201-204 or in the local security gateway itself. Destination wallet 322 provides the destination for incoming FT cryptocurrency transactions, for example, with funds from a source wallet 320. These incoming transactions can be from source wallets 320 in remote security gateways 201-204 or in the local security gateway itself. Registry client 324 provides a client for registering newly created assets with the registry 210. Authentication layer 302 provides various methods of authentication for the different types of data sources 302 supported by the security gateways 201-204. Data source 302 broadly encompasses any source of data, and represents the source of DOI.

In various examples, the data sources 302 may be IoT data sources, data sources from persons, and anything capable of generating data (e.g., a server with a log file).

Next, a subsystem labeled subsystem 4 will be discussed. Registry 210 allows security gateways 201-204 to register new assets (e.g., FTs, NFTs or combinations of FTs and NFTs or nested combinations of FTs and NFTs) with specific data sources 302. DOI writer 370 home security gateway identification (SGW-ID) of a specific data source 302 with its respective combination of FTs and NFTs. Ecosystem filter 374 provides ecosystem governance for the data-metadata-ownership information that can/must/must-not be shared with the other security gateways of the blockchain network. Sharing filter 380 provides the home SGW-ID to control which data-metadata-ownership information will be shared with other security gateways in the blockchain network. Granular controls allow for a per-security gateway filter of data-metadata-ownership information. DOI reader 382 provides the ‘SGW-IDs’ of the specific security gateways in the blockchain network that have at least some ‘READ’ ability for the data-metadata-ownership information related to the data source 302 from a foreign, or separate, security gateway from the blockchain network.

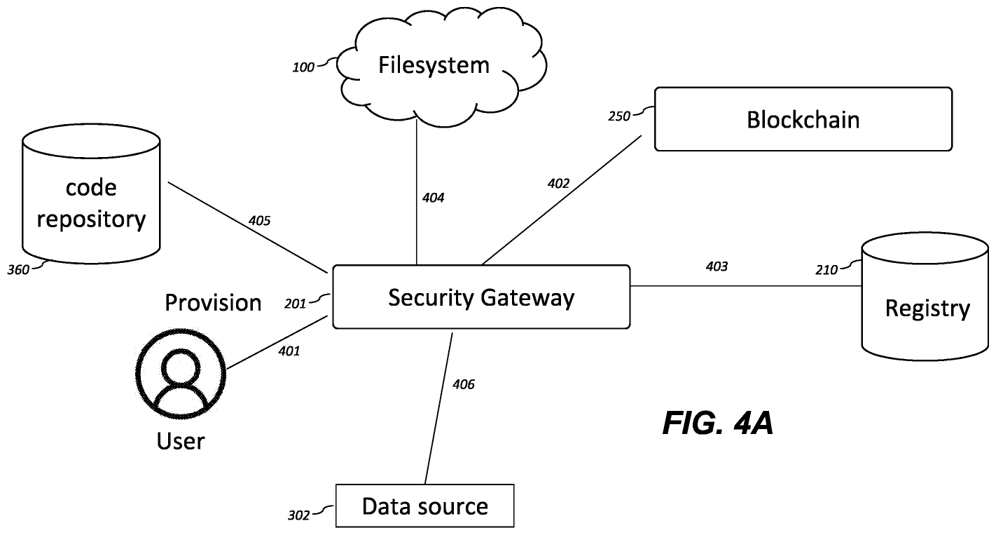

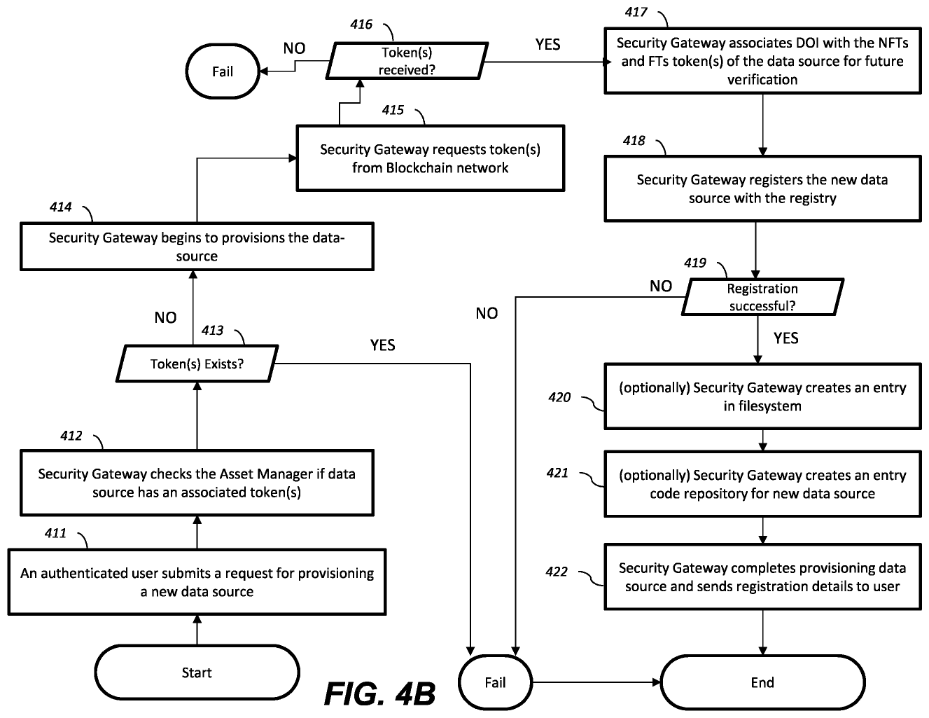

FIGS. 4A-4B illustrates data source provisioning, in accordance with one or more aspects set forth herein, and demonstrate the interaction of the components depicted in FIG. 4A, which were previously described above.

For instance, in one example flowchart, at block 411, an authenticated user submits a request for provisioning a new data source including a list of what is required.

Next, at block 412 Security Gateway 201-204 checks the Asset Manager 310 if data source has an associated token(s). Next, at block 413 Security Gateway 201-204 makes a determination is made whether tokens exist, and if yes, the flowchart ends via fail state. Next, at block 414, if no tokens exist, Security Gateway begins to provision the data-source. Next, at block 415 Security Gateway requests token(s) from Blockchain network. Next, at block 416 a determination is made if tokens are received, and if no, the flowchart ends via fail state. Next, at block 417, if yes, Security Gateway associates DOI with the NFTs and FTs token(s) of the data source in the Asset Manager 310 for future verification. Next, at block 418 Security Gateway registers the new data source with the registry. For example, the following information is included in the registration request:
A unique identifier for the data source for the particular ecosystem.
Designation as an FT/NFT
Fields of metadata
Fields of data
Fields to be shared, which could be:
   The whole ecosystem (all participants)
   S-IDs to share particular fields with
   Business Rules for sharing (e.g., conditions that need to be met before data can be shared with a particular S-ID)

Next, at block 419 a determination is made if registration is successful and if no, the flowchart ends via fail state. Next, at block 420, if yes, Security Gateway can optionally create an entry in File System 100. Next, at block 421 the Security Gateway can optionally create an entry in the code repository 360 for the new data source Next, at block 421 Security Gateway completes provisioning the data source and sends registration details to the authenticated user who submitted the request in block 411.

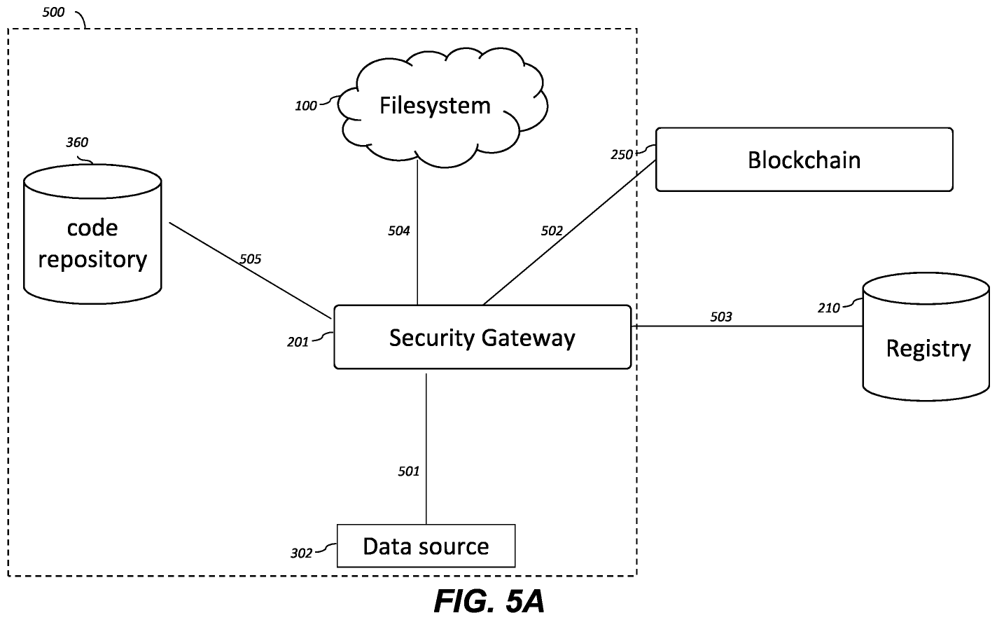

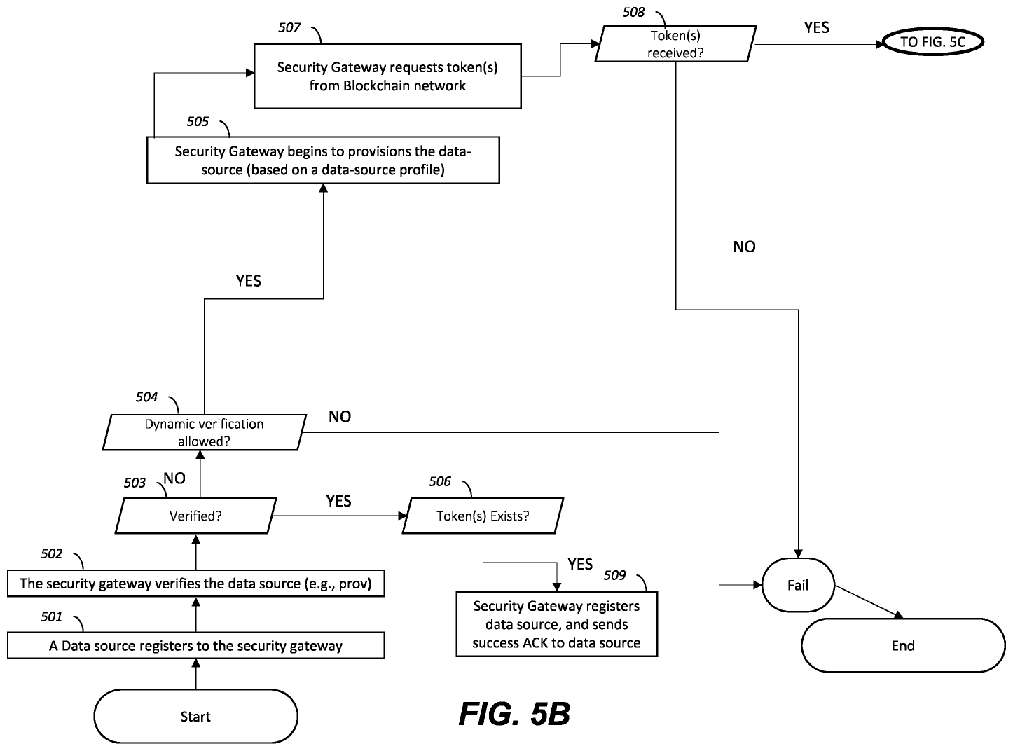

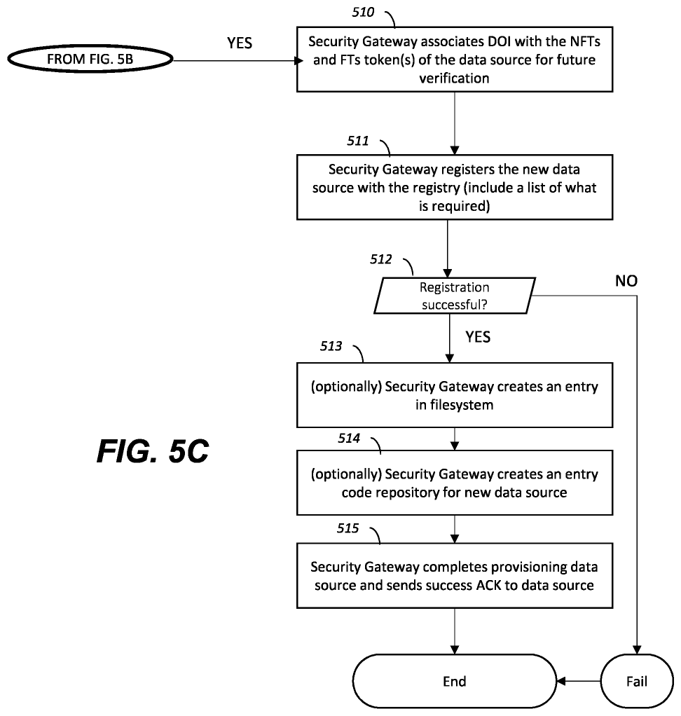

FIGS. 5A-5C illustrates data source registration, in accordance with one or more aspects set forth herein, and demonstrate the interaction of the components depicted in FIG. 4A, which were previously described above.

For instance, in one example flowchart, at block 501 a data source 302 registers to a security gateway 201-204. Next, at block 502 a security gateway 201-204 verifies the data source (e.g., has the data source been provisioned—but there could be other forms of verification, such as is the data source already registered or verified). Next, at block 503 a determination is made if the data source is verified or not. Next, at block 506 a determination is made if token(s) exist in the Asset Manager 310. Next, if yes, at block 509 of FIG. 5B, a security gateway 201-204 registers the data source 302, and sends success ACK to the data source 302. Going back to block 503, if yes, at block 504 a determination is made if dynamic verification is allowed. Next, if yes, at block 505 the security gateway 201-204 begins to provisions the data-source 302 which could be (based, for example or in one implementation, on a pre-existing profile for the data-source profile). Next at block 507 the Security Gateway 201-204 requests Blockchain network. Next, if no, at block 508 security gateway requests token(s) from blockchain network. Next, at block 509 a determination is made if token(s) are received. Next, at block 510 a security gateway associates DOI with the NFTs and FTs token(s) of the data source for future verification. Next, at block 511 a security gateway associates DOI with the NFTs and FTs token(s) of the data source for future verification. Next, at block 512 a determination is made if registration is successful. Next, at block 513 (optionally) a security gateway creates an entry in file system. Next, at block 514 (optionally) a security gateway creates an entry code repository for new data source. Next, at block 515 a security gateway completes provisioning data source and sends success ACK to data source. Next, at block 515 a security gateway completes provisioning data source and sends success ACK to data source.

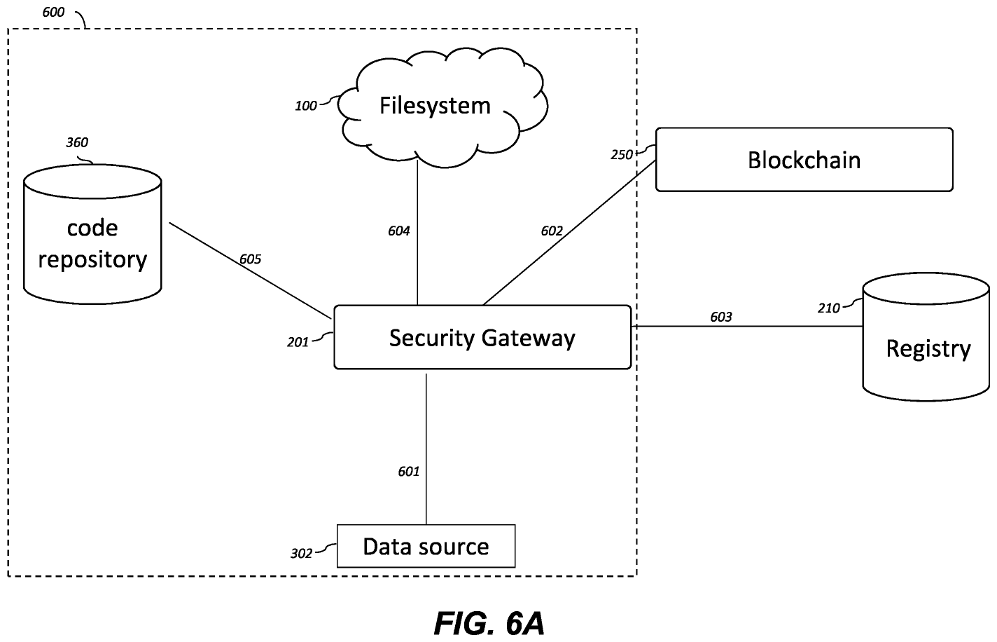

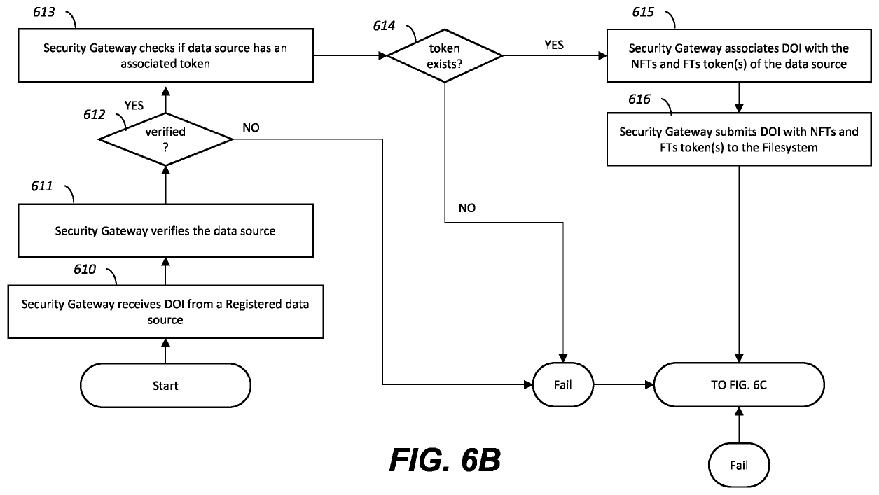

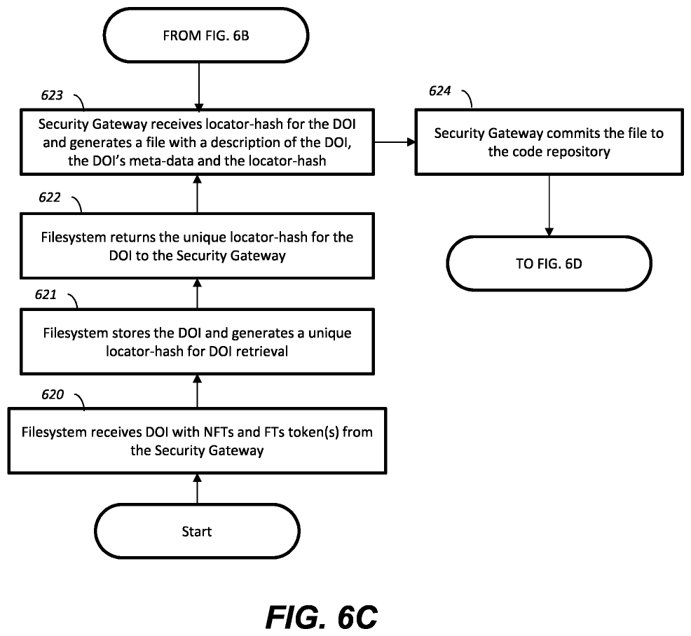

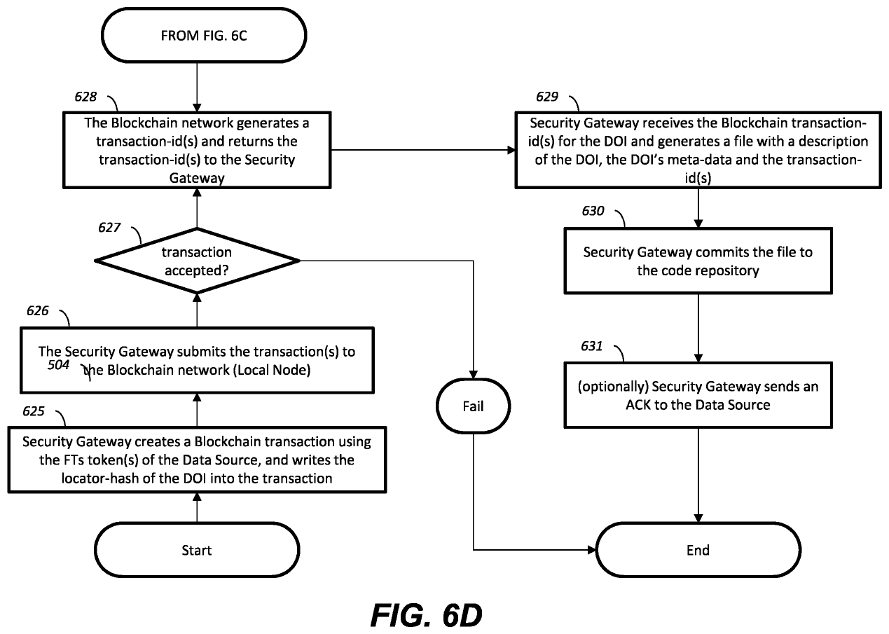

FIGS. 6A-6D illustrates writing data of interest, in accordance with one or more aspects set forth herein, and demonstrate the interaction of the components depicted in FIG. 4A, which were previously described above.

For instance, in one example flowchart, at block 610 Security Gateway 201-204 receives DOI from a Registered data source 302. Next, at block 611 a security gateway 201-204 verifies the data source 302 with the Asset Manager 310. Next, at block 612 a determination is made if the data source is verified. Next, if yes, at block 613 a security gateway 201-204 checks if data source 302 has an associated token. Next, at block 614 a determination is made if a token exists. Next, if yes, at block 615 a security gateway 201-204 associates the DOI with the NFTs and FTs token(s) of the data source. Next, at block 616 a security gateway submits DOI with NFTs and FTs token(s) to the file system. Next, at block 617 of FIG. 6C, a file system receives DOI with NFTs and FTs token(s) from a security gateway. Next, at block 618 a file system stores the DOI and generates a unique locator-hash for DOI retrieval. Next, at block 619 a file system returns the unique locator-hash for the DOI to a security gateway. Next, at block 620 a security gateway receives locator-hash for the DOI and generates a file with a description of the DOI, the DOI's meta-data and the locator-hash. Next, at block 621 a security gateway commits the file to the code repository. Next, at block 622 a security gateway creates a blockchain transaction using the FTs token(s) of the Data Source, and writes the locator-hash of the DOI into the transaction. Next, at block 623, the Security Gateway submits the transaction(s) to the Blockchain network (Local Node).

Next, at block 624 a determination is made if the transaction is accepted. Next, if yes, at block 625 the blockchain network generates a transaction-id(s) and returns the transaction-id(s) to the security gateway. Next, at block 626 a security gateway receives the blockchain transaction-id(s) for the DOI and generates a file with a description of the DOI, the DOI's meta-data and the transaction-id(s). Next, at block 627 a security gateway commits the file to the code repository. Next, at block 628 (optionally) a security gateway sends an ACK to the data source.

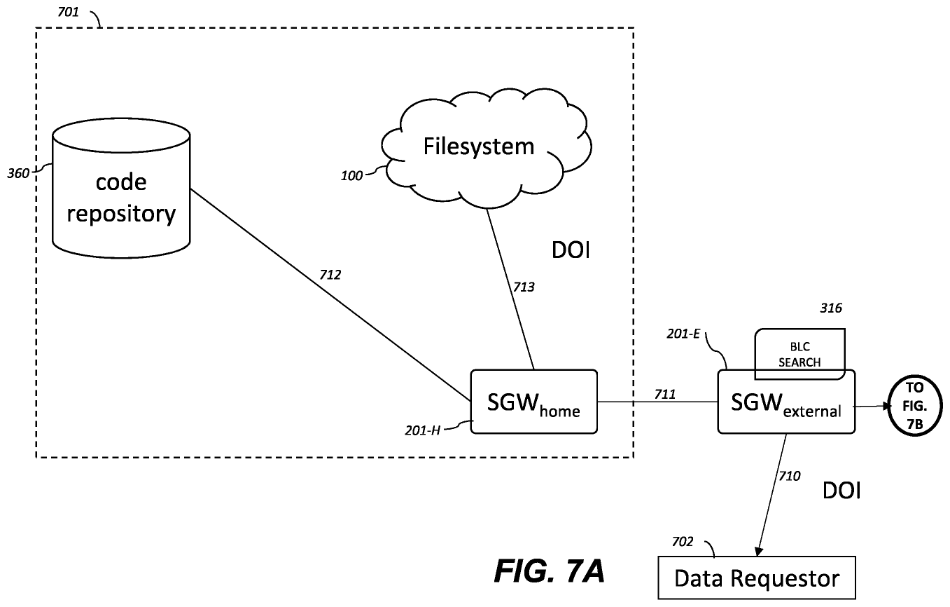

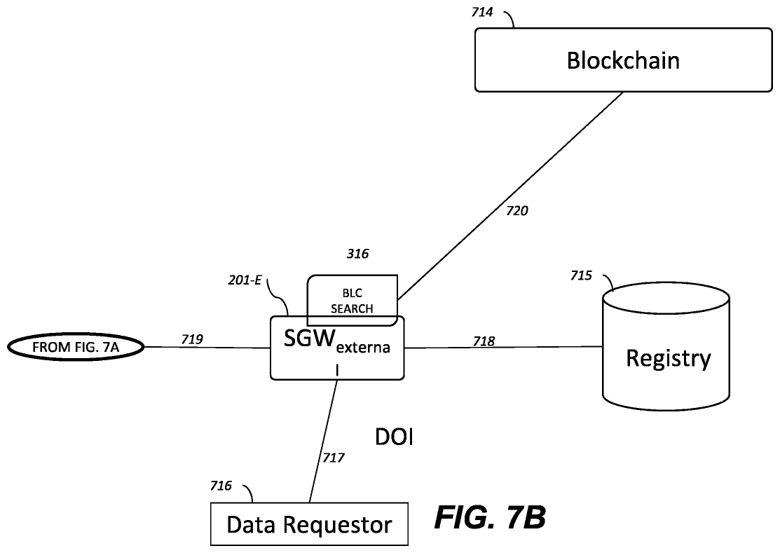

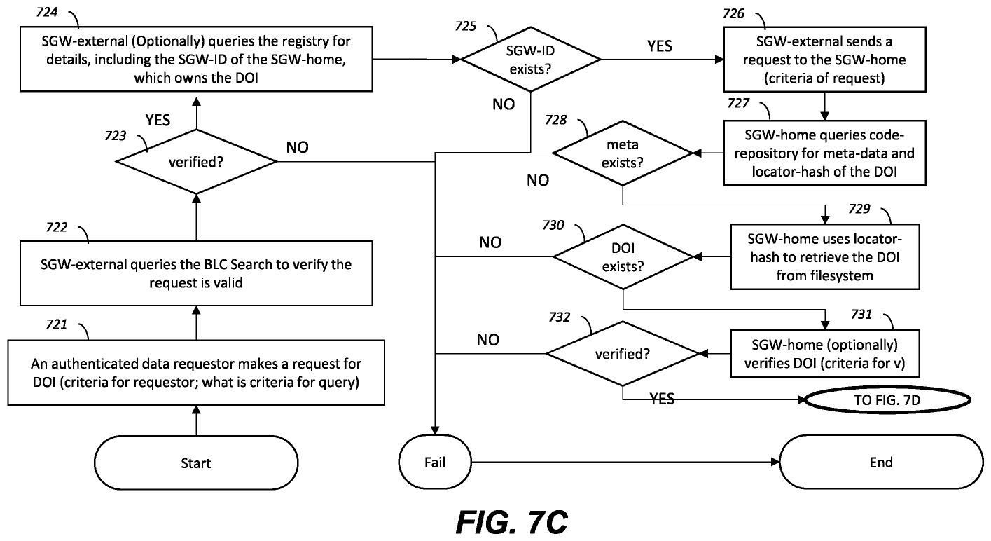

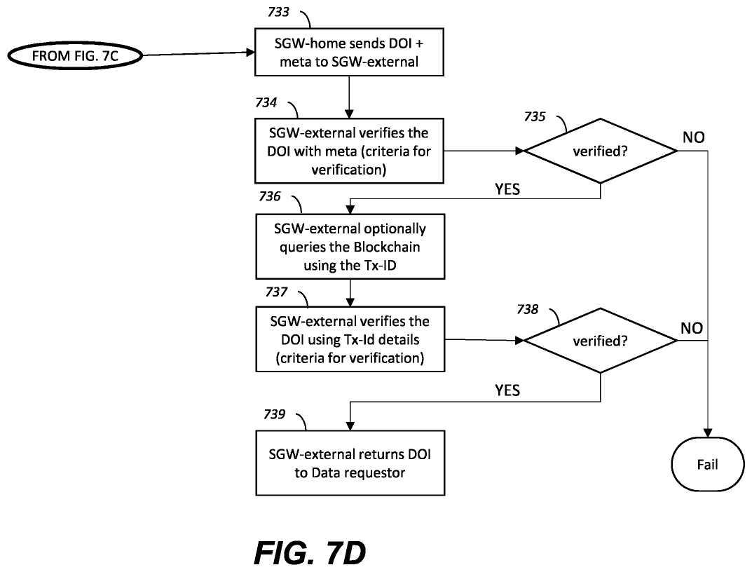

FIGS. 7A-7D illustrate reading data of interest, in accordance with one or more aspects set forth herein, and demonstrate the interaction of the components depicted in FIG. 4A, which were previously described above.

For instance, in one example flowchart, at block 721 an authenticated data requestor makes a request for DOI, including, e.g.: criteria for requestor; and criteria for query. Next, at block 722 SGW-external queries the BLC Search to verify the request is valid. Next, at block 723 a determination is made if the request is verified. Next, at block 724 SGW-external (optionally) queries the registry for details, including the SGW-ID of the SGW-home, which owns the DOI. Next, at block 725 a determination is made if SGW-ID exists. Next, if yes, at block 726 SGW-external sends a request to the SGW-home (criteria of request). Next, at block 727 SGW-home queries code-repository for meta-data and locator-hash of the DOI. Next, at block 728 a determination is made if meta exists. Next, if yes, at block 729 SGW-home uses locator-hash to retrieve the DOI from file system. Next, at block 730 if DOI exists. Next, if yes, at block 731 SGW-home (optionally) verifies DOI (criteria for v). Next, at block 732 a determination is made if DOI is verified. Next, if yes, at block 733 SGW-home sends DOI+meta to SGW-external. Next, at block 734 SGW-external verifies the DOI with meta (criteria for verification). Next, at block 735 a determination is made if DOI is verified. Next, if yes, at block 736 SGW-external optionally queries the Blockchain using the Tx-ID. Next, at block 737 SGW-external verifies the DOI using Tx-Id details (criteria for verification). Next, at block 738 a determination is made if criteria is verified. Next, if yes, at block 739 SGW-external returns DOI to Data requestor.

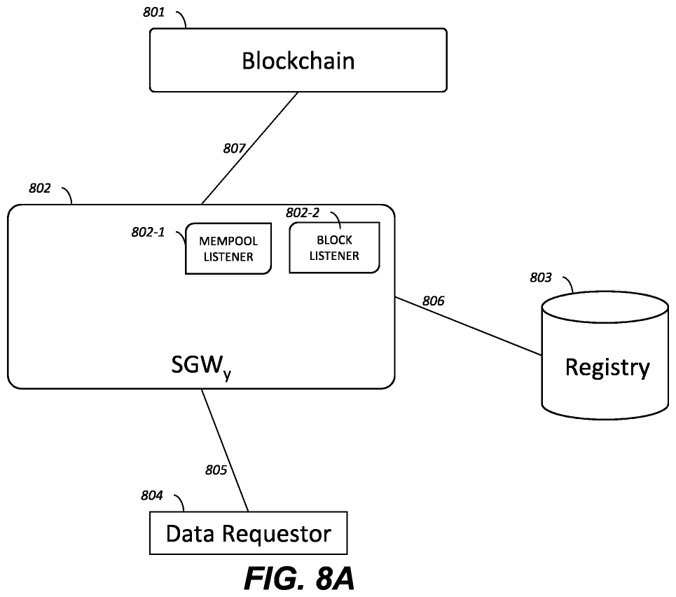

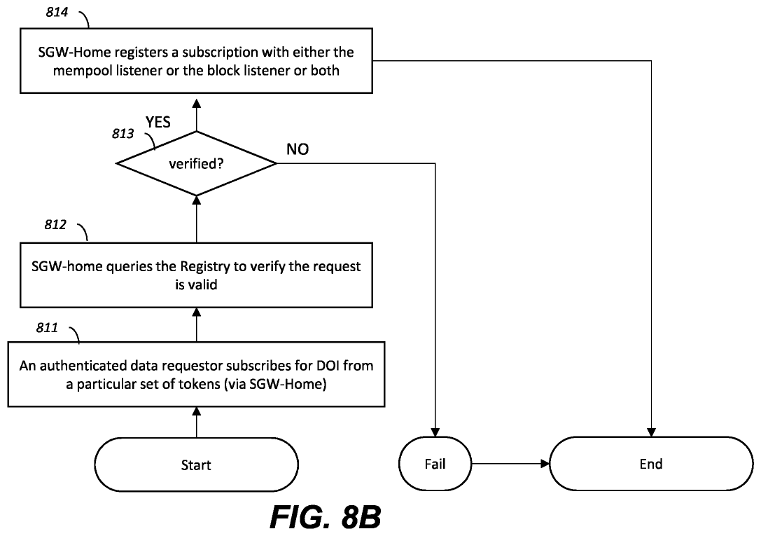

FIGS. 8A-8B illustrates data subscription, in accordance with one or more aspects set forth herein, and demonstrate the interaction of the components depicted in FIG. 4A, which were previously described above.

For instance, in one example flowchart, at block 811 an authenticated data requestor subscribes for DOI from a particular set of tokens (via SGW-Home). Next, at block 812 SGW-home queries the registry to verify the request is valid. Next, at block 813 a determination is made if the request is verified. Next, at block 814, SGW-Home registers a subscription with either the mempool listener or the block listener or both.

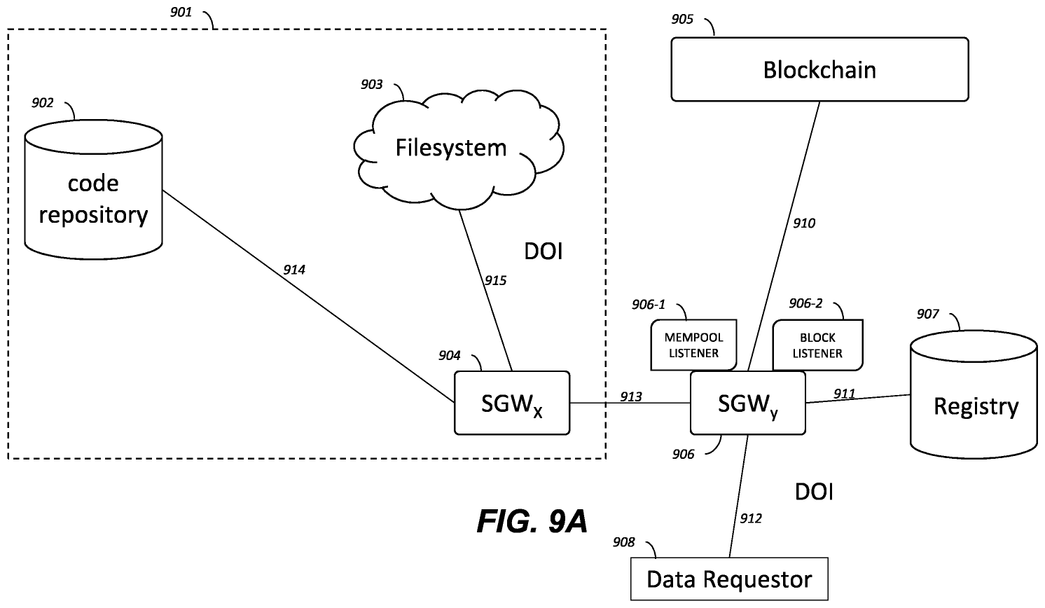

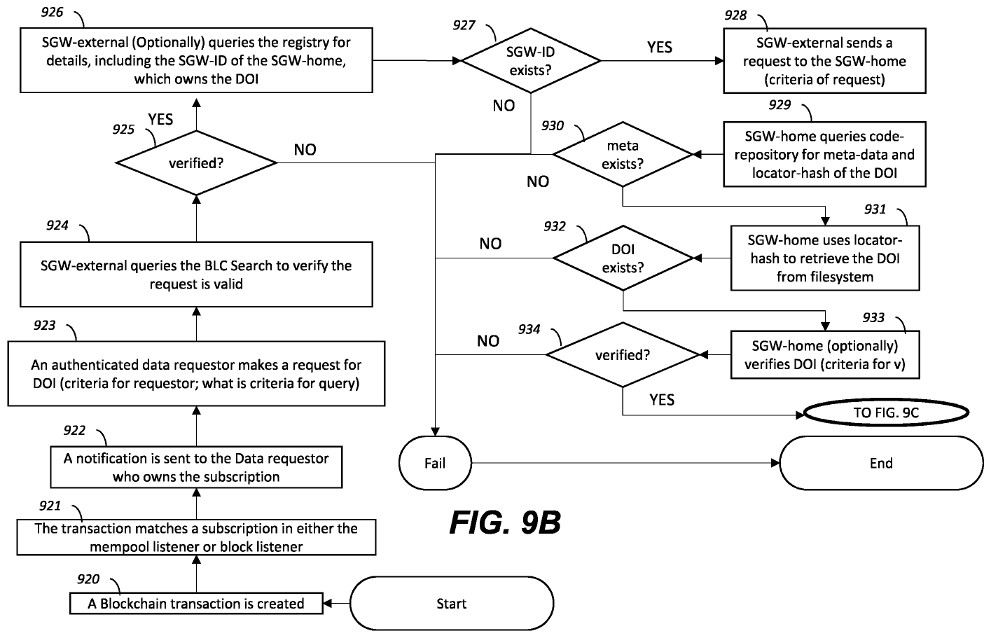

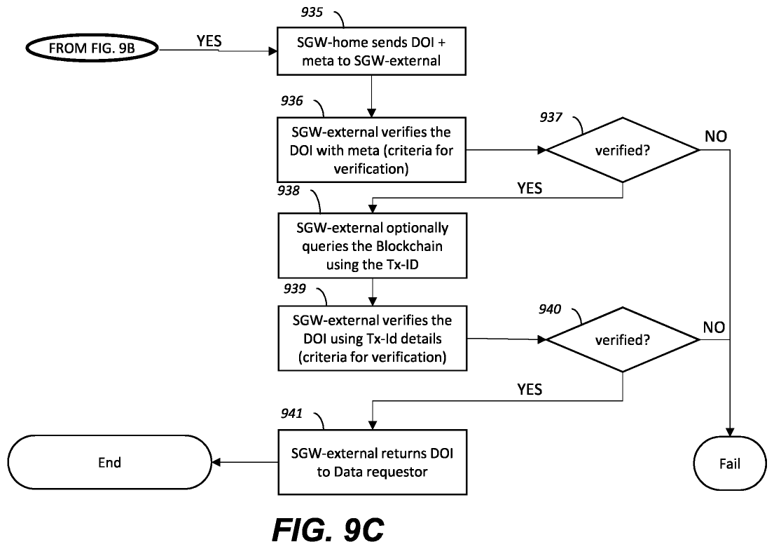

FIGS. 9A-9C illustrates data notification and retrieval, in accordance with one or more aspects set forth herein, and demonstrate the interaction of the components depicted in FIG. 4A, which were previously described above.

For instance, in one example flowchart, at blocks 920, 921 a blockchain transaction is created. Next, at block 922 a notification is sent to the data requestor who owns the subscription

Next, at block 923 an authenticated data requestor makes a request for DOI (criteria for requestor; what is criteria for query). Next, at block 924 SGW-external queries the BLC search to verify the request is valid. Next, at block 925 a determination is made if the request is verified. Next, at block 926 SGW-external (optionally) queries the registry for details, including the SGW-ID of the SGW-home, which owns the DOI. Next, at block 927 a determination is made if SGW-ID exists. Next, at block 928 SGW-external sends a request to the SGW-home (criteria of request). Next, at block 929 SGW-home queries code-repository for meta-data and locator-hash of the DOI. Next, at block 930 a determination is made if meta data exists. Next, at block 931 SGW-home uses locator-hash to retrieve the DOI from file system. Next, at block 932 a determination is made if DOI exists. Next, at block 933 SGW-home (optionally) verifies DOI (criteria for v). Next, at block 934 a determination is made if DOI is verified. Next, at block 935 SGW-home sends DOI+meta to SGW-external. Next, at block 936 SGW-external verifies the DOI with meta (criteria for verification). Next, at block 937 a determination is made if the DOI is verified. Next, at block 938 SGW-external optionally queries the blockchain using the Tx-ID. Next, at block 939 SGW-external verifies the DOI using Tx-Id details (criteria for verification). Next, at block 940 a determination is made if the DOI is verified. Next, at block 941 SGW-external returns DOI to data requestor.

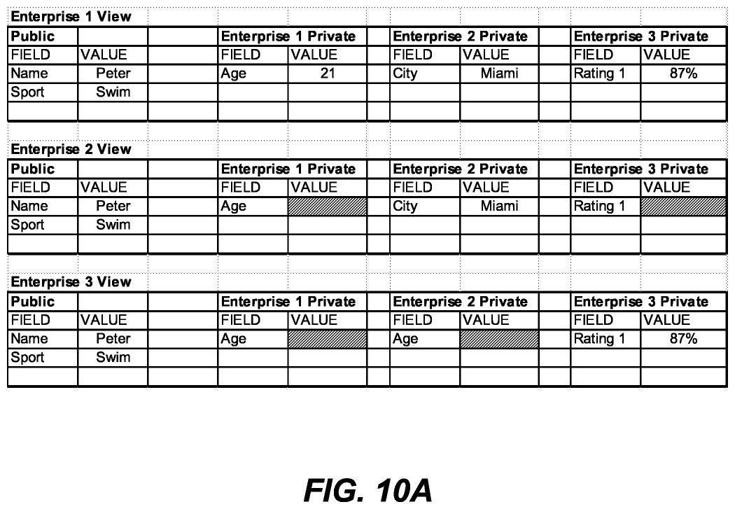

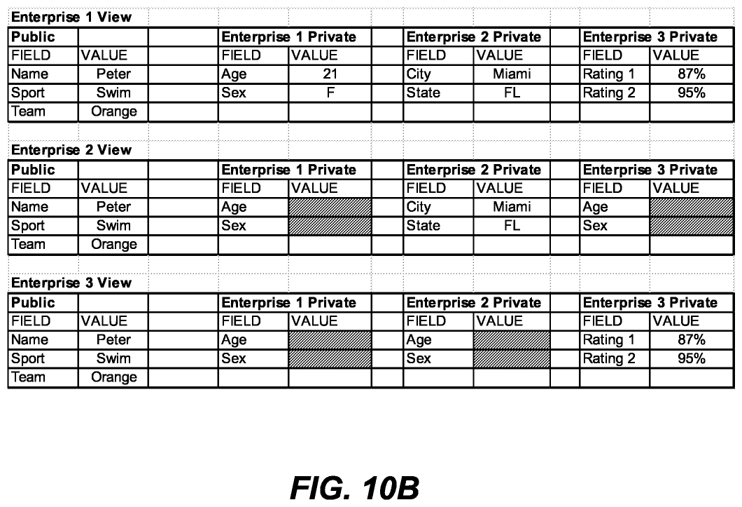

FIGS. 10A-10B illustrates a working example of the distributed file system of the present disclosure. FIGS. 10A-10B depict data, in the form of tables, stored in three different enterprises, labeled Enterprise 1-3. columns designated “Private” represent data that is private to a given enterprise, and columns designated “Public” represent data that is public to all enterprises. In the particular example given, Enterprise 1 has been allowed to have access to all data, both Public and Private.

Continuing with the working example of FIGS. 10A-10B, FIG. 10A represents the state of the data at a first time, and FIG. 10B represents the state of the data at a subsequent time after changes have been made as will now be explained.

At the first time, as shown in FIG. 10A, the distributed file system includes five distinct Field/Value pairs of data, having the following Fields which have values and public and private designations as follows:
Field: Name; Value: Peter; Public/Private Designation: Public
Field: Sport; Value: Swim; Public/Private Designation: Public
Field: Age; Value: 21; Public/Private Designation: Enterprise 1 Private
Field: City; Value: Miami; Public/Private Designation: Enterprise 2 Private
Field: Rating 1; Value: 87%; Public/Private Designation: Enterprise 2 Private

FIG. 10A represents the condition of the distributed file system that enforces accessibility to data. In particular, all enterprises are allowed to see what fields are defined in the system, but only Enterprise 1 may see Enterprise 1 Private data, and so on. Therefore, as depicted in FIG. 10A by the greying out of the values, each enterprise can see the public data and only its own private data.

FIG. 10B represents the condition of the distributed file system after new data has been added. Specifically, the following data has been added:
Field: Team; Value: Orange; Public/Private Designation: Public
Field: Sex; Value: F; Public/Private Designation: Enterprise 1 Private
Field: State; Value: FL; Public/Private Designation: Enterprise 2 Private
Field: Rating 2; Value: 95; Public/Private Designation: Enterprise 2 Private

Once again, as seen in FIG. 10B, the distributed file system enforces that each enterprise can see the public data and only its own data.

Thus, FIGS. 10A-10B provide a working example of the system described herein. Advantageously, and with respect to this working example, the system described herein allows many enterprises to participate in a distributed file system in a way that allows each enterprise to only be able to have access and control over certain data, but ensures that all participants can trust that the data may only be changed in a secure and traceable manner.

Embodiments of the present disclosure may include a system, a method, and/or a computer program product. The computer program product may include a computer readable storage medium (or media) having computer readable program instructions thereon for causing a processor to carry out aspects of set forth herein.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the certain embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects set forth herein.

Embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A distributed file system for secure multi-party computing access to a plurality of distributed files, the distributed file system comprising:
a cloud-based data store configured to store the plurality of distributed files and regulate secure multi-party computing access to the plurality of distributed files;
at least one tracking system configured to track transactions related to the plurality of distributed files, the transactions including at least read transactions and write transactions;
a distributed ledger comprising at least one block chain, the distributed ledger being configured to validate the transactions related to the plurality of distributed files;
a first enterprise access system comprising a first local data store and having access to the cloud-based data store, the at least one tracking system and the distributed ledger; and
a second enterprise access system comprising a second local data store and having access to the cloud-based data store, the at least one tracking system and the distributed ledger,
wherein the distributed file system enables the first and second enterprise access systems to access at least one distributed file of the distributed file system, the at least one distributed file comprising multiple data structures,
wherein the distributed file system regulates the first enterprise access system to allow first transactions on a first subset of the multiple data structures and the second enterprise access system to allow second transactions on a second subset of the multiple data structures, such that the first and second subsets are different subsets and the first and second transactions are different transactions, and
wherein the distributed file system tracks the first and second transactions using the at least one revision tracking system and validates the first and second transactions using the distributed ledger.

2. The distributed file system of claim 1, wherein the distributed file system is configured such that the first enterprise access system creates a first distributed file and the cloud-based data store regulates the second enterprise access system such that the second enterprise access system has access to a subset of data structures of and transactions related to the first distributed file.

3. The distributed file system of claim 1, wherein the distributed file system is configured such that: the first enterprise access system changes a distributed file; the second enterprise access system receives a notification related to the changes of the distributed files; the second enterprise access system validates the changes of the distributed files; and a third enterprise access system is provided access to the distributed file responsive to the validation of the changes by the second enterprise access system.

4. The distributed file system of claim 1, wherein the distributed file system is configured such that each distributed file of the plurality of distributed files comprises multiple data structures, and each distributed file is stored as a non-fungible token by the at least one blockchain and each of the multiple data structures is stored as a fungible token by the at least one blockchain.

5. The distributed file system of claim 1, wherein the distributed file system enables the first enterprise access system and the second enterprise access system to subscribe to events related to the plurality of distributed files.

6. A distributed file system for secure multi-party computing access to a plurality of distributed files, the distributed file system comprising:
a cloud-based data store configured to store the plurality of distributed files and regulate secure multi-party computing access to the plurality of distributed files;
at least one tracking system configured to track transactions related to the plurality of distributed files, the transactions including at least read transactions and write transactions;
a distributed ledger comprising at least one block chain, the distributed ledger being configured to validate the transactions related to the plurality of distributed files;
a first enterprise access system comprising a first local data store and having access to the cloud-based data store, the at least one tracking system and the distributed ledger; and
a second enterprise access system comprising a second local data store and having access to the cloud-based data store, the at least one tracking system and the distributed ledger,
wherein the distributed file system enables the first and second enterprise access systems to access at least one distributed file of the distributed file system, the at least one distributed file comprising multiple data structures,
wherein the distributed file system regulates the first enterprise access system to allow first transactions on a first subset of the multiple data structures and the second enterprise access system to allow second transactions on a second subset of the multiple data structures, such that the first and second subsets are different subsets and the first and second transactions are different transactions, and
wherein the distributed file system tracks the first and second transactions using the at least one revision tracking system and validates the first and second transactions using the distributed ledger;
wherein the distributed file system is configured such that each distributed file of the plurality of distributed files comprises multiple data structures, and each distributed file is stored as a non-fungible token by the at least one blockchain and each of the multiple data structures is stored as a fungible token by the at least one blockchain.
